(19) United States
(12) Patent Application Publication
(10) Pub. No.: US 2009/0197236 A1
(43) Pub. Date: Aug. 6, 2009

(54) IMPLEMENTING USER-GENERATED FEEDBACK SYSTEM IN CONNECTION WITH PRESENTED CONTENT

(76) Inventor: Howard William Phillips, II, Woodinville, WA (US)

Correspondence Address: LAW OFFICES OF RONALD M ANDERSON, 600 108TH AVE, NE, SUITE 507, BELLEVUE, WA, 98004, US

(21) Appl. No.: 12/366,893

(22) Filed: Feb. 6, 2009

Related U.S. Application Data
(60) Provisional application No. 61/026,522, filed on Feb. 6, 2008.

(51) Int. Cl. G09B 3/00

(52) U.S. Cl. 434/350

(57) ABSTRACT

Users are enabled to provide structured feedback in connection with interactive presentations by responding to a plurality of predefined questions in connection with a plurality of author predefined points. As each question is presented, the user responds and is then presented with a plurality of supporting statements. The user can either selectively access statement details for one of the supporting statements or accept the statements. A plurality of peer-user responses are presented for each of the questions and the user selects one or more of the peer-user responses as corresponding to the user's response. The responses and selections made by users are collected as user feedback data. A scoring system presents relative scores for the responses by the peer users based on the selections, thereby generating feedback useful to content authors in editing and updating their presentations. This approach for collecting user feedback data is also applicable to other applications.

### RELATED APPLICATIONS

This application is based on a prior copending provisional application, Ser. No. 61/026,522, filed on Feb. 6, 2008, the benefit of the filing date of which is hereby claimed under 35 U.S.C. § 119(e).

### BACKGROUND

The education training, and communications fields regularly use presentations intended to deliver content, transfer knowledge, and create understanding. These pre-authored one-to-many group presentations lack embedded mechanisms to ensure that content meaning and relevance is established with their intended audiences. These presentations are typically authored by “experts” (educators and trainers) who do not share the audience's perspectives on the presentation content, which often results in elements of the presentations not being understood or appreciated by the intended audience. Attempts to address this problem by presenting multiple perspectives within a single content set have achieved only modest results due to the limitations of conventional methods in incorporating a sufficiently broad range of perspectives and language styles. Attempts to address this problem by incorporating peer-user generated content in a presentation have achieved only modest results due to the limitations of conventional methods in accessing user responses to content and in using the resulting data to filter content for display to individual users or audience participants.

With conventional methods, the addition of peer-user generated content either overwhelms the individual user with content in quantities too great to reasonably navigate and consume, or underwhelms the individual user with content that regularly does not resonate with them individually. Systems attempting to address this problem have achieved only limited results because they lack the mechanisms necessary to generate peer-user generated content of a kind sufficiently broad and varied, and they lack one or more purpose-built filtering algorithm(s) such that the filtered subsets of the peer-user generated content are useful to each individual user. Authors attempting to address this problem have achieved only limited results as they lack presentation feedback of the type necessary for them to perform effective corrective edits and refinements to the content of their presentation. Presentations are, therefore, frequently inefficient and ineffective at achieving knowledge transfer and insuring that the content is understood by and has perceived relevance to the audience.

### SUMMARY

Accordingly, a novel method for collecting user feedback data regarding a presentation enables the content quality of a presentation to be improved based upon the user feedback data. The user feedback data also can be employed in other applications where details relating the understanding and beliefs of a user or groups(s) of users are important to ascertain.

An exemplary embodiment of the method begins with the step of presenting a predefined point related to a topic of the presentation to a user on a display screen and/or as an audio signal. The predefined point is then followed with the presentation of a predefined question associated with the predefined point. (As used herein, the terms “present” or “presented” in regard to information or text is intended to broadly encompass both visual and/or audible output of the information or text.) The user is requested to input a response to the predefined question, and the response is stored in a non-volatile storage as part of the user feedback data being collected. A plurality of predefined supporting statements that are in a context of the predefined question to which the user input a response are then presented for review by the user. The user is able to either select one or more of the plurality of supporting statements so that details for the supporting statement selected are presented to the user, or simply accept the plurality of supporting statements. If the user selects one or more of the supporting statements to access further details, an indication of the supporting statement(s) that was/were selected is stored as part of the user feedback data, in the non-volatile storage. A plurality of peer-user responses to the predefined question are next presented, along with the response input by the user. The user is enabled to select one or more of the plurality of peer-user responses, and an indication of the response(s) selected is stored as part of the user feedback data, in the non-volatile storage. A newly selected plurality of peer-user responses to the predefined question is next presented, along with both the response input by the user, and a plurality of predefined supporting statements that are in a context of the predefined question to which the user input a response. Based on the user feedback data collected for all users, a relative score can be presented for each of the plurality of peer-user responses and supporting statements that are in a context of the predefined question to which the user input a response.

For each point and topic, a user is presented with “best” peer-user responses twice, specifically, once with the peer point and topic responses, and again, in the point and topic summary. The first instance includes peer-user point and topic responses that are automatically selected based in part on the responses of the user up to that time in the interaction. The second instance includes selections of the peer point and topic responses that reflect the addition of the user's selections, for the initial instance. The automated selection of peer-user point and topic responses to present to the user for the first instance is two-fold. In an exemplary embodiment, two of four peer responses presented to the user are selected based on the user's interaction with the presentation up to that time, while the other two responses that are presented to the user are selected in part based on the user's interaction with the system and in part based on the number of times the specific peer response has been displayed to a user in the past and the number of times it has been selected by a user in the past, and to serve as seeds for further user interactions.

In one embodiment, the user can access the presentation over a network using a computing device that communicates with at least one other computing device, such as a server. When part of the user feedback data is stored, that part of the data is conveyed over the network to a remote data store comprising the non-volatile storage. To enable the user to access the presentation, the predefined point is conveyed to the user over the network from the other computing device. The steps noted above are repeated for each of a plurality of predefined points and corresponding predefined questions comprising the presentation for which user feedback data are being collected. The final review enables the user to interact with the predefined points and supporting statements, previous responses input by the user to questions, and peer-user responses to the questions. During this review, the user can suggest additional points or suggest revisions to the predefined points to more clearly indicate what the user believes are important relative to the topic.

The method can further include the step of presenting to the user a topic revisited question for which the user inputs a user topic question response, peer-user topic question responses from which the users chooses the “best” responses, and a final topic summary that presents the user topic question responses, the peer-user topic question responses, and each predefined point, and presenting a relative score for each peer-user topic question response and predefined point.

If the user inputs a comment to an author or a presentation regarding statement details, the method can include the step of enabling the author to input a response to the comment that is stored in the non-volatile storage so that the user input comment and author input response can be made available for future review by the user.

If the user inputs a comment to an author or a presentation regarding statement details and the author inputs a response to the comment, the method can include the step of causing a plurality of “paired” user comments and author responses to be presented to the user. The specific paired user comments and author responses that are presented can be selected automatically based upon the user's interaction with the system up to that time.

If the user selects one of the plurality of supporting statements and thereby causes statement details to be presented, the method can include the step of enabling the user to input a comment to an author of the presentation regarding the statement details. The comment input by the user is then stored as part of the user feedback data, in the non-volatile storage, so that the author of the presentation can view the comment.

The user can also be enabled to modify the response that the user previously input for a predefined question, for example, after viewing the plurality of peer-user responses, but also, at other times while interacting with the presentation. If modified, the response is again stored in the non-volatile storage, as part of the user feedback data.

When presenting the plurality of peer-user responses to the user, the method provides for selecting and presenting the peer-user responses for peer users who are most like the user in responding to the presentation. In one embodiment, to select the peer-user responses, an interaction parameter is determined for the peer users that is an indication of how closely the interactions with the presentation of the peer users are like those of the user—up to that time in the presentation. In addition, a selection parameter is determined for the peer users that is an indication of how closely the selections by the peer users of options presented are like selections made by the user, up to that time in the presentation. Finally, the interaction parameter and the selection parameter for each of the other peer users in regard to the user are combined, to provide a proximity value that indicates the peer users who are most like the user in reviewing the presentation, and the peer-user responses from among the peer users having the highest proximity values are selected for presentation to the user.

Another aspect of this novel approach is directed to a memory medium on which are stored machine readable and executable instructions for collecting user feedback data regarding a presentation. When executed by a processor, these instructions generally cause the processor to carry out functions that are consistent with the steps of the method discussed above.

Yet another aspect of the approach is directed to a system that includes a user computing device. The user computing device has a memory in which are stored machine readable and executable instructions, an output device on which text and graphics are presented to a user, and an input device for providing a user input. The output device may be a display for visually presenting the text and graphics to a user, or alternatively, or in addition to a display, may include an audio transducer for audibly presenting information, instructions, and options to the user. A processor is coupled to the memory, the output device, the input device, and the non-volatile storage and executes the machine readable and executable instructions to carry out a plurality of functions that are again generally consistent with the steps of the method discussed above.

This application specifically incorporates by reference the disclosures and drawings of the patent application identified above as a related application.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a diagrammatic representation of an exemplary computing environment suitable for obtaining real-time user-generated feedback in connection with the content of a presentation;

FIG. 2 is a diagrammatic representation of a networked computing environment for carrying out some aspects of a system and method that implement real-time user-generated feedback in connection with presented content;

FIG. 3A is a flowchart of a method for implementing a real-time user-generated feedback system in presented content in a computer-networking environment according to an embodiment of an invention disclosed herein;

FIG. 3B is a chart illustrating an example showing hypothetical interaction “paths” taken by a current user and other users in a presentation that has already been completed by the other users;

FIG. 3C is a chart illustrating an example showing hypothetical user response selections and peer-user point response (“PPR”) selections made respectively by a current user and by other users, in a presentation that has already been completed by the other users;

FIG. 3D is a flowchart illustrating an exemplary sequence of steps that are carried out during a user's review of a presentation, but is only a subset of the overall method indicated in FIG. 3A; and

FIGS. 4-20 are exemplary flowcharts and examples of user interfaces that illustrate the context of a method for implementing a real-time user-generated feedback system in presented content in a computer-networking environment.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

According to one embodiment, an exemplary system and exemplary method of implementation are directed to providing individual users with presentations that comprise pre-authored “expert” content, in connection with selectively filtered “peer”-generated content, interspersed with the user's own user-generated content. The expert content and the peer content are presented sequentially and always in the context of the user-generated content. As users progress through a presentation sequence, they witness the contrast between their own perspectives, those of the “expert,” and the most helpful of those of their peers. Further, they are able (and encouraged during the process) to modify their own user-generated content such that it improves the clarity of their expression and better reflects any changes to their own beliefs and understanding.

The expert content and the peer-generated content are presented in a manner that continually scores and filters each content element for display (or audio presentation), according to user interactions with it. The content scoring and filtering takes into account a number of variables such as the choice, number, order, and promptness of the interactions as these factors relate to other interactions with the user, peer users who have similar interaction behaviors, or other identifiable characteristics, and all users.

The aforementioned scoring and filtering are contrasted with some or all user interaction data from the specific content interaction, some or all content interactions within the specific presentation module, and some or all content interactions within all presentation modules. As the number of users who interact with the presentation increases, the helpfulness to users of the peer-generated content identified via the selective filtering process also increases.

The authors' ability to review these processes and study the user feedback provides them with increased insight into the most useful user perspectives. In one embodiment, authors also enjoy increased ability to identify and effectively refine the most troublesome expert content as a result of their exposure to presentation feedback sourced from only those users having issues with that specific content element as well as to identify common misconceptions and misunderstandings on the part of users. Authors can thus better understand their presentation audience and make more effective edits to the content they are presenting. This improvement in the content based on input from users provides pre-authored content, peer-generated content, user-generated content, and entire presentations that have greater meaning and relevance to individual users.

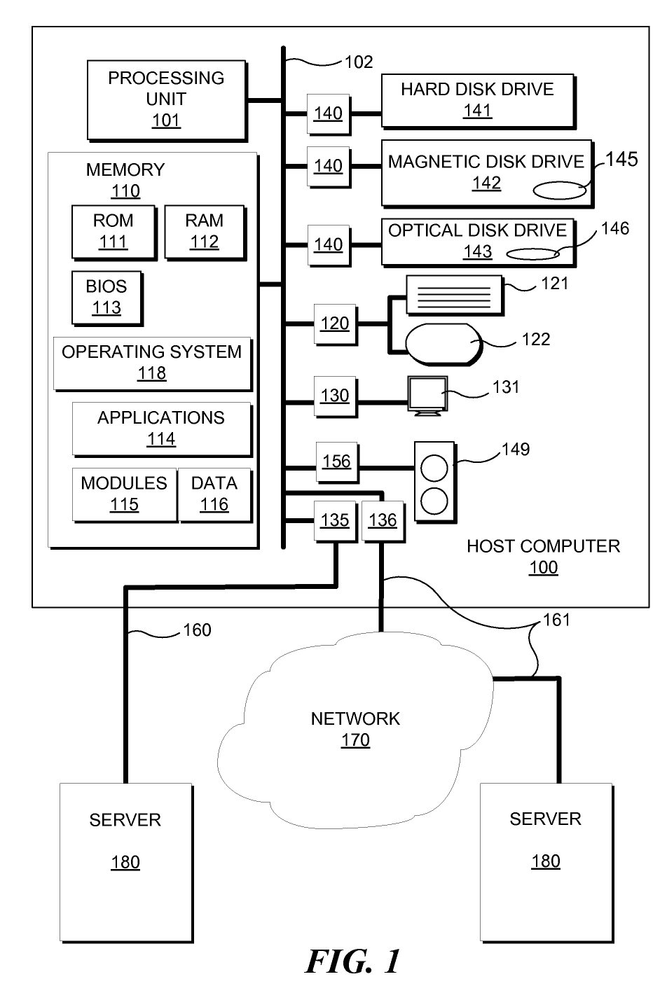

FIG. 1 and the following discussion are intended to provide a brief, general description of an exemplary computing environment suitable for implementing some embodiments of the present novel approach. Although not required, this novel approach is described in the general context of computer-executable instructions, such as program modules, that can be executed by a conventional personal computer. Generally, program modules include routines, programs, objects, components, data structures, etc. that collectively perform particular tasks or implement particular abstract data types. Moreover, those skilled in the art will appreciate that the present novel approach may be practiced with other computer system configurations, including hand-held devices, multiprocessor systems, microprocessor-based or programmable consumer electronics, network PCs, minicomputers, mainframe computers, and the like. The present novel method may also be practiced in distributed computing environments where tasks are performed by remote processing devices that are linked through a communications network. In a distributed computing environment, program modules may be located in both local and remote memory storage devices. As a result, various exemplary embodiments described herein may be practiced in mobile computing environments, such as those that use mobile web-phones, hand-held games systems, personal digital assistants (PDAs), and by implementing mesh networking between devices.

With reference to FIG. 1, an exemplary system for implementing the invention includes a general purpose computing device in the form of a conventional personal computer 100, including a processing unit 101, a system memory 110, and a system bus 102 that couples various system components including a system memory 110 to the processing unit 101. System bus 102 may be any of several types of bus structures including a memory bus or memory controller, a peripheral bus, or a local bus using any of a variety of bus architectures. System memory 110 includes a read-only memory (ROM) 111 and a random-access memory (RAM) 112. A basic input/output system (BIOS) 113, containing the basic routines that help to transfer information between elements within the personal computer 100, such as during start-up, is stored in system memory 110. System memory 110 may further include program applications 114 and program modules 115.

Personal computer 100 may further include a hard disk drive 141 for reading from and writing to a hard disk (not shown), a magnetic media drive 142 for reading from and/or writing to a removable magnetic disk 145, and an optical media drive 143 for reading from and/or writing to a removable optical disk 146 such as a CD ROM or other optical media. Hard disk drive 141, magnetic media drive 142, and optical media drive 143 are connected to system bus 102 by one or more media interfaces 140. The drives and their associated computer-readable media provide both volatile and nonvolatile storage of computer readable instructions, data structures, program modules, and other data that may be accessed by personal computer 100.

Although the exemplary environment described herein employs a hard disk, and may include a removable magnetic disk and a removable optical disk, it should be appreciated by those skilled in the art that other types of computer-readable media that can store data that are accessible by a computer, such as magnetic cassettes, flash memory cards, digital versatile disks, Bernoulli cartridges, random access memories (RAMs), read only memories (ROMs), and the like, may also be used in the exemplary operating environment.

A number of program modules may be stored on the hard disk, magnetic disk, optical disk, ROM 111 or RAM 112, including an operating system 118, one or more application programs, other program modules, and program data 116. A user may enter commands and information into personal computer 100 through input devices such as a keyboard 121 and a pointing device 122 (e.g., a mouse). Other input devices (not shown) may include a microphone, joystick, game pad, satellite dish, scanner, or the like. These and other input devices are often connected to the processing unit 101 through an input interface 120 that is coupled to system bus 102. Input interface 120 may be a serial port, a parallel port, a game port, a universal serial bus (USB), or any other appropriate interface. A monitor 131 or other type of display device is also connected to system bus 102 via an interface, such as a video interface 130. One or more speakers 149 (or other type of audio transducer, such as headphones) are also connected to system bus 102 via an interface, such as an output peripheral interface 156. In addition to the monitor and speakers, personal computer 100 may include other types of peripheral input devices, and/or output devices, such as a printer (not shown). It will be apparent that other configurations of computing devices can be employed for providing a presentation and accepting interactive input from a user to facilitate collection of user-generated feedback data. For example, the computing device may be configured as a smartphone.

Personal computer 100 may operate in a networked environment using logical connections to one or more remote computers, such as a remote computer 180. Remote computer 180 may be another personal computer, a server, a router, a network personal computer, a peer device, or other common network node, and typically, the remote computer or other such device may include many or all of the elements described above, relative to personal computer 100. The logical connections depicted in FIG. 1 include a local area network (LAN) 160, and a wide area network (WAN) 161. Such networking environments are commonplace in offices, enterprise-wide computer networks, intranets, and in connection with access to the Internet. As depicted in FIG. 1, remote computer 180 communicates with personal computer 100 via LAN 160 over a network 170, through a network interface 135. The personal computer may also communicate with remote computer 180 through WAN 161, for example, through a modem/network interface card 136 or using another remote communications interface device.

When used in a LAN networking environment, personal computer 100 is connected to LAN 160 through a network interface or adapter 135. When used in a WAN networking environment, personal computer 100 typically includes a modem 136 or other means for establishing communications over the wide area network 161, such as the Internet. In a networked environment, program modules depicted relative to personal computer 100, or portions thereof, may be stored in a remote memory storage device. It will be appreciated that the network connections shown are exemplary and that other means of establishing a communications link between the computers may alternatively be used.

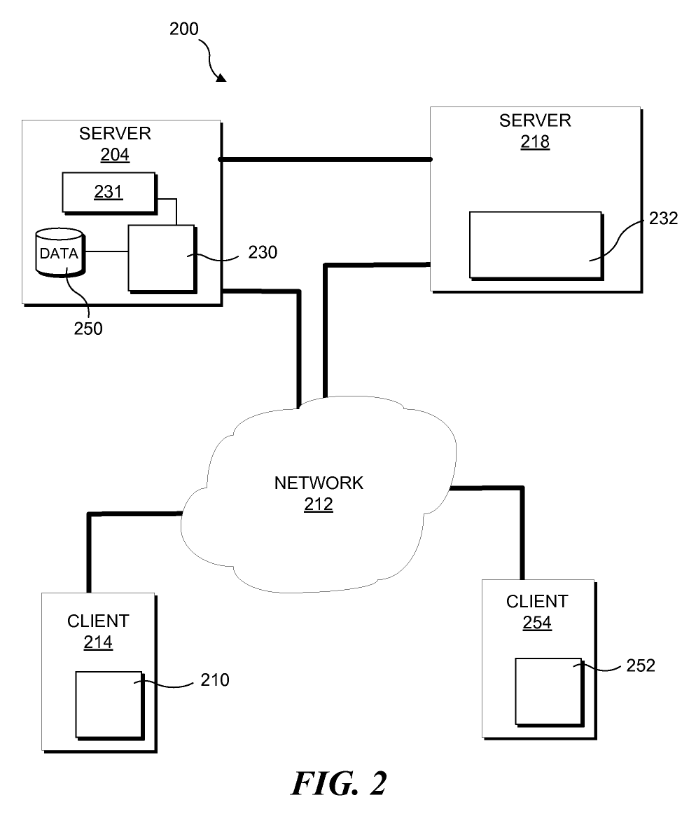

FIG. 2 is a diagrammatic representation of an exemplary networked computing environment 200 that illustrates how users operating client computing devices 214 and 254, for example, may interact with a presentation 232 accessed on a server 218 over a network 212 (such as the Internet, a wide area network, or a local area network, or via a combination of any of different types of networks). At least some aspects of the present novel system and method for implementing a real-time user-generated feedback system in presented content may be practiced within this exemplary networked computing environment. In this example, the client computing devices present text, input boxes, and options to the user on displays 210 and 252, which are respectively included with client computing devices 214 and 254. Alternatively (or in addition), the text and other options might be presented audibly to the user. While the user-generated feedback data provided by users might be stored in non-volatile storage by server 218, in this example, user-generated feedback data 250 are instead stored on a hard drive (not separately shown) by a server 204, that can include a display 230 and is executing a software program or module 231, to control storage and access to the user-generated feedback data. The nature of the data and the manner in which the data are collected are explained below.

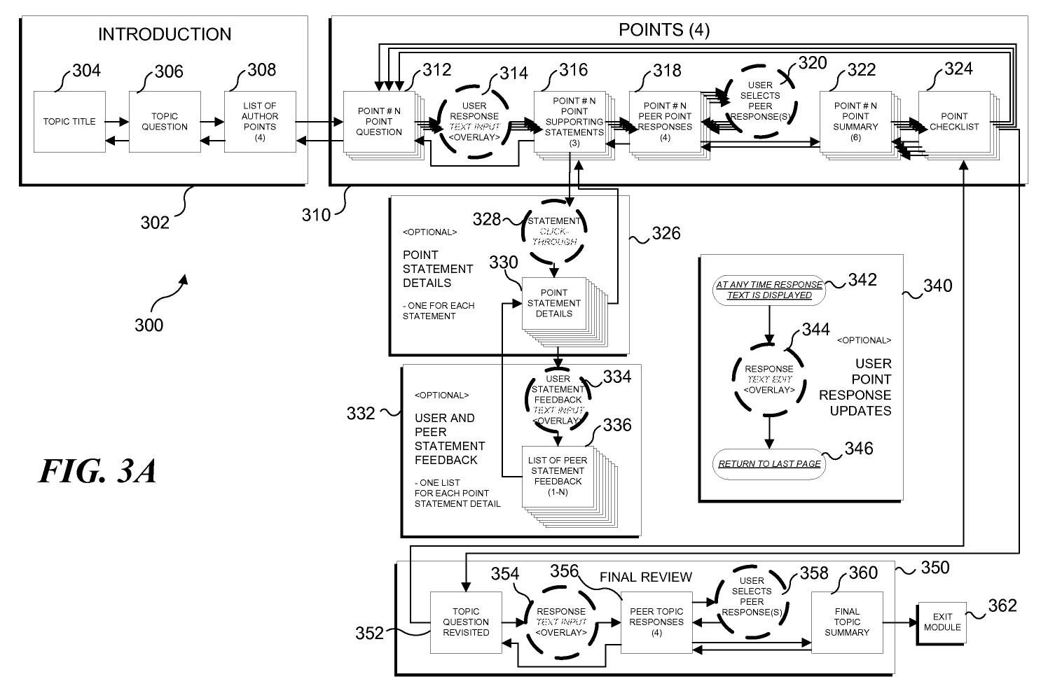

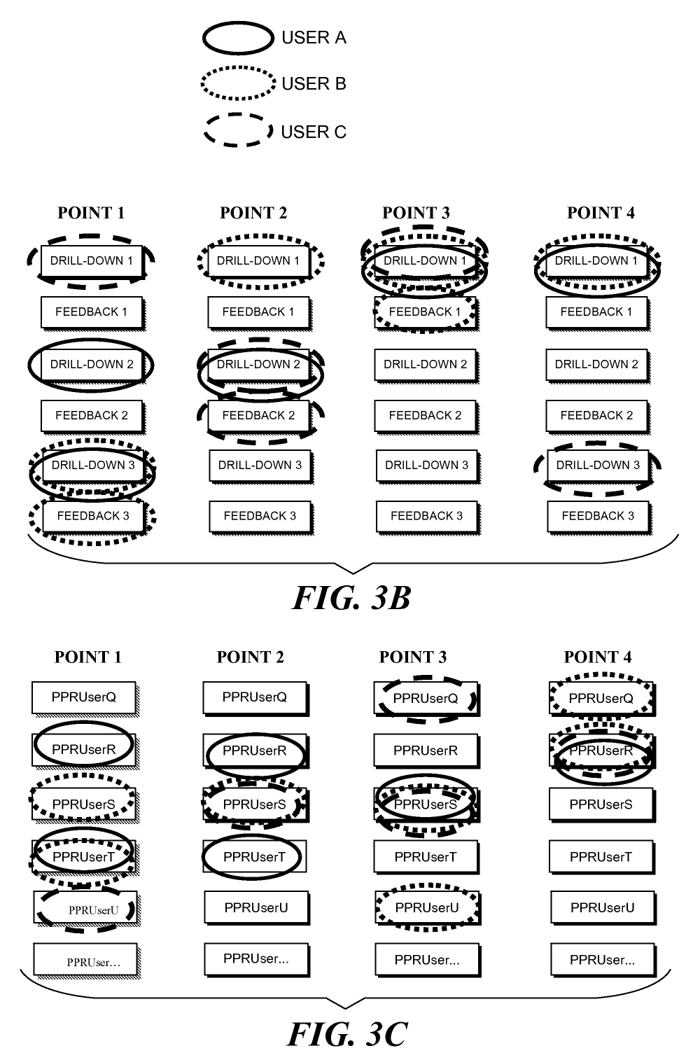

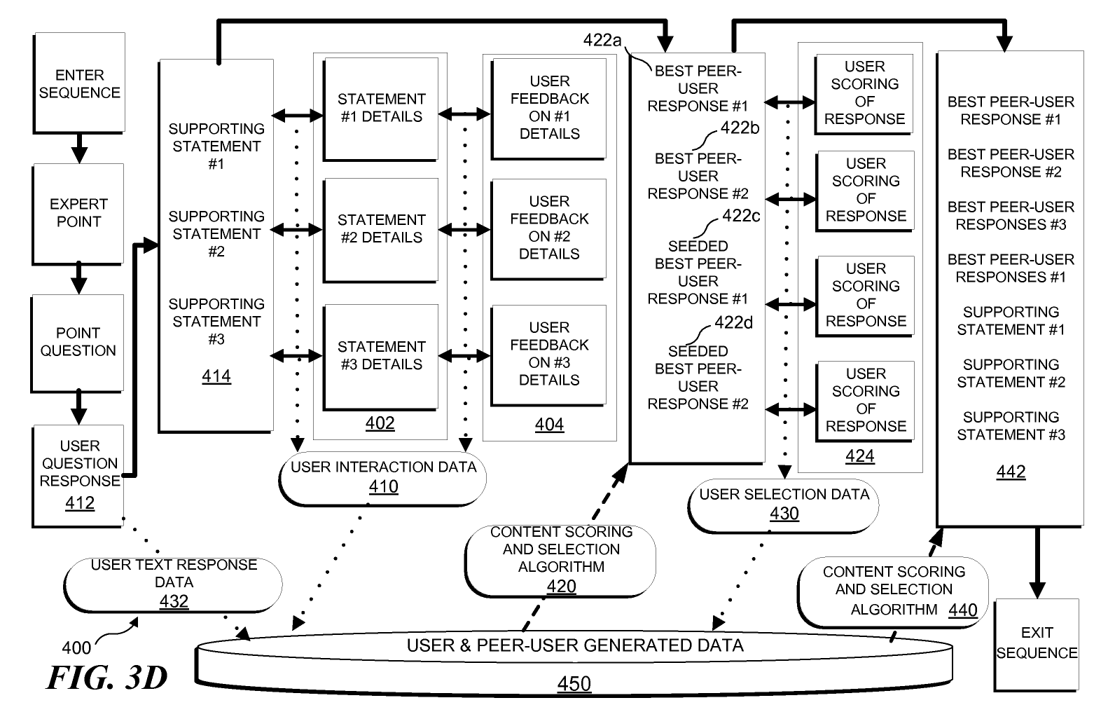

FIG. 3A illustrates further details of an exemplary approach for practicing the present novel method. In the exemplary embodiment shown in FIG. 3A, a computer user may be presented with an interactive presentation with a content sequence and structure. In accord with the present novel approach, a user is able to provide feedback about the presentation and review feedback from other users that both improve the user's understanding and appreciation of the presentation and are useful for enabling the author of the presentation to improve it so that it more meaningfully conveys information to subsequent users who access it. The user feedback data can also be used in other applications, since such data provide a more in-depth indication of user response to statements included in the presentation. For example, such user feedback data might be much more useful as a determination of users' feelings, opinions, and preferences about political figures or specific questions than conventional survey polls. Other applications for user feedback data are in connection with the marketing of products or services, where it can be important to understand the consumer response to the products or service and how changes might impact future sales. These are just examples of the application for the user feedback data that are interactively collected using the present novel approach, and it should be clearly understood that such exemplary applications are not intended to in anyway be limiting.

### Exemplary Flowcharts Charts, and Screen Layouts Illustrating the Novel Approach

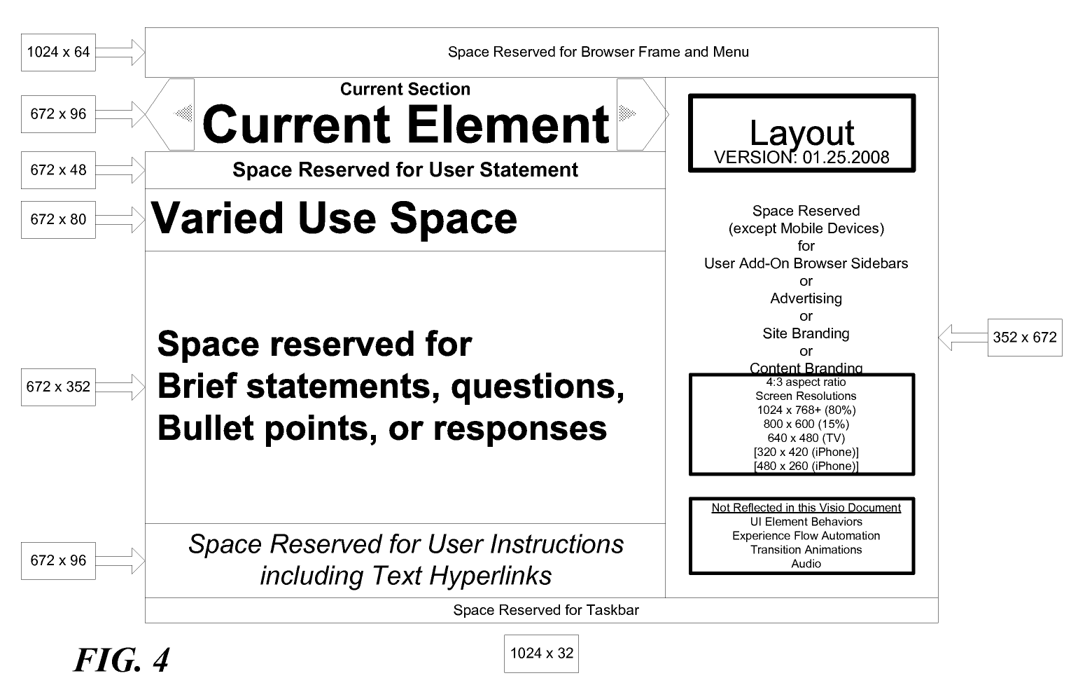

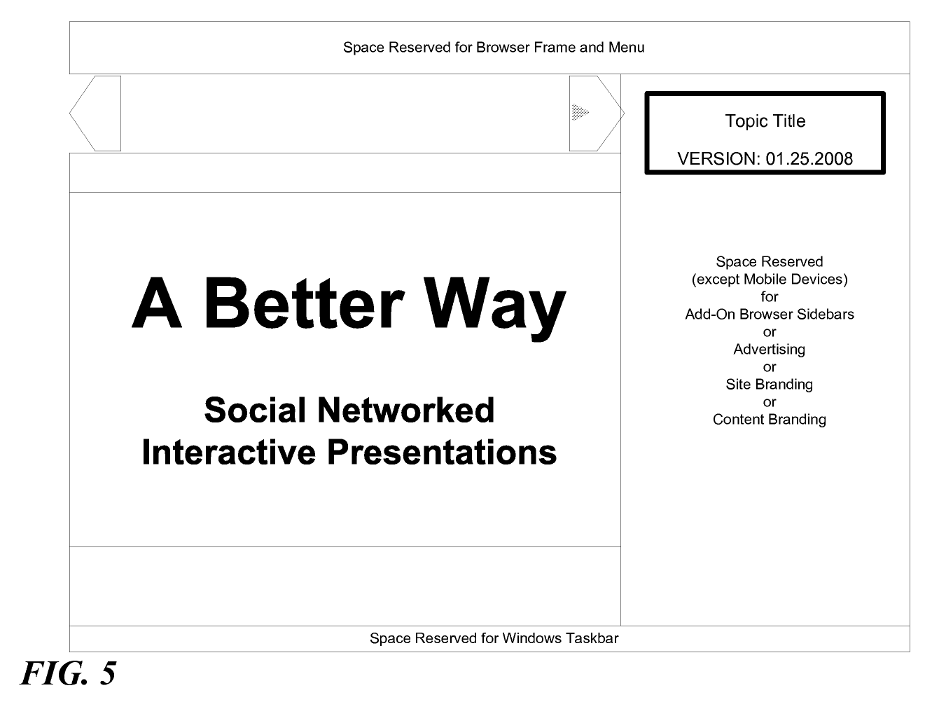

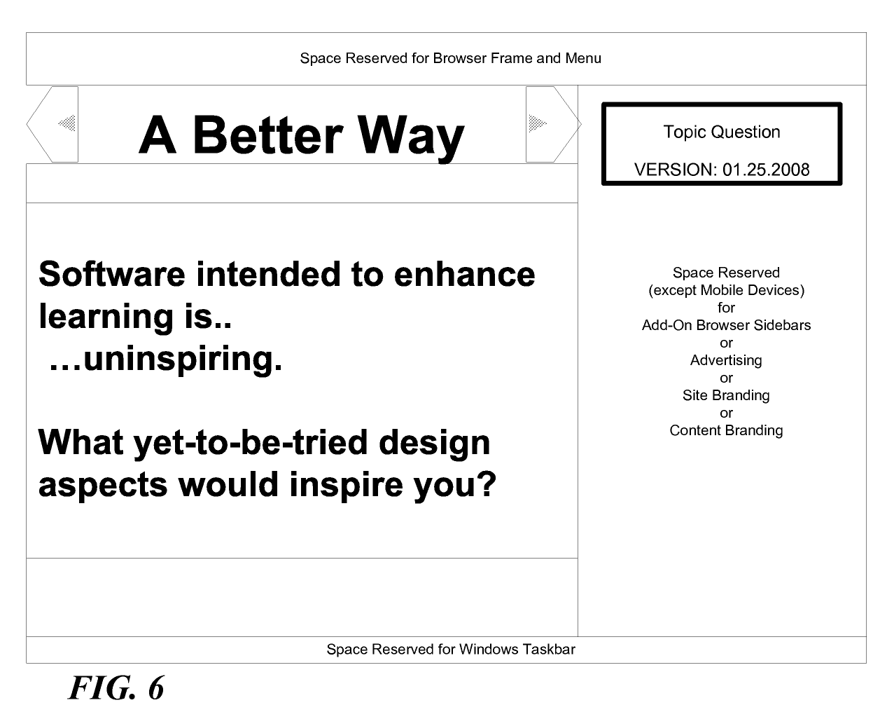

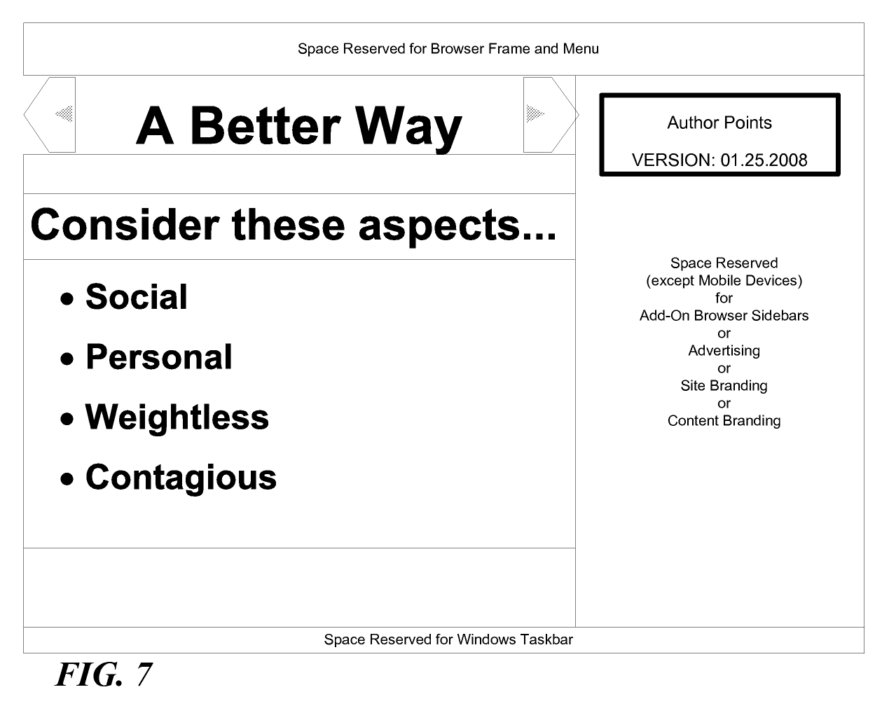

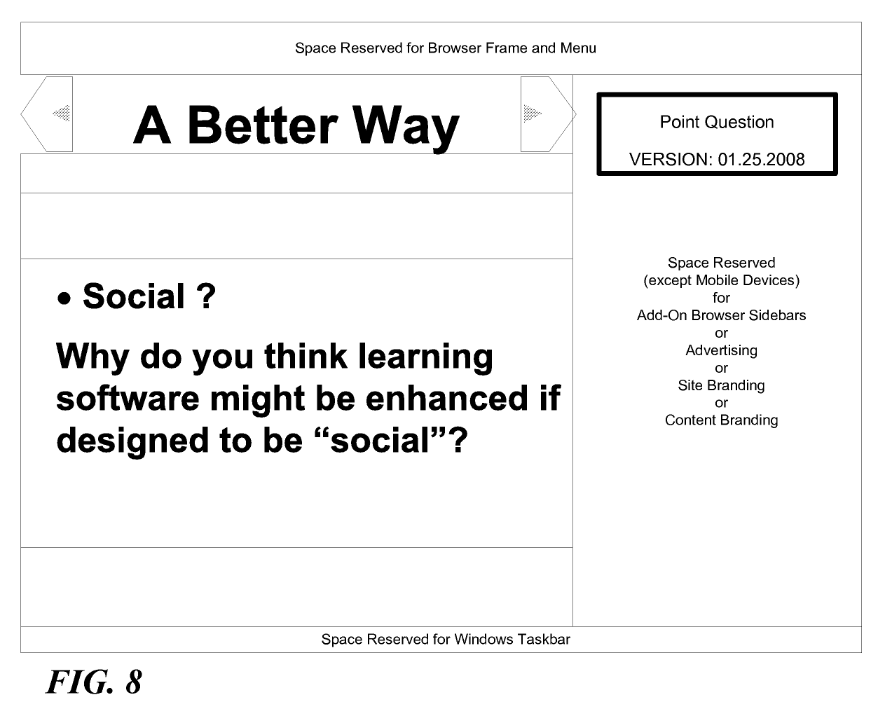

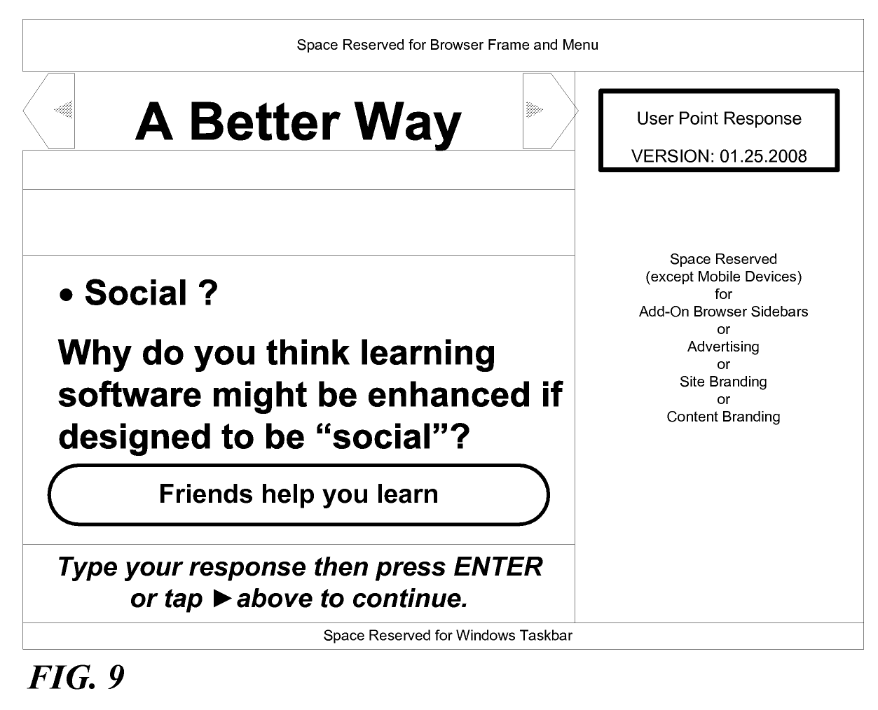

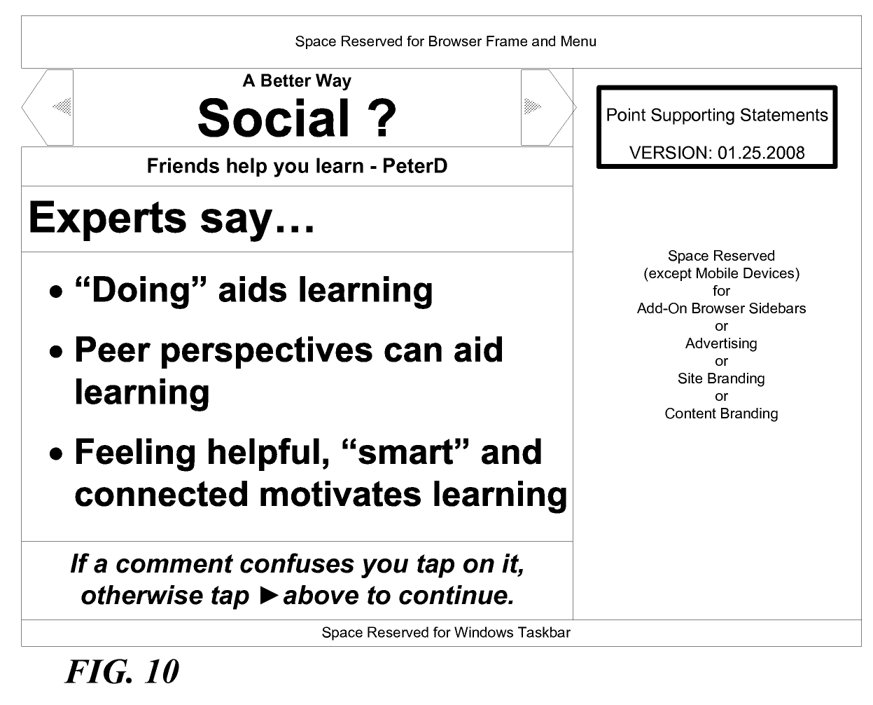

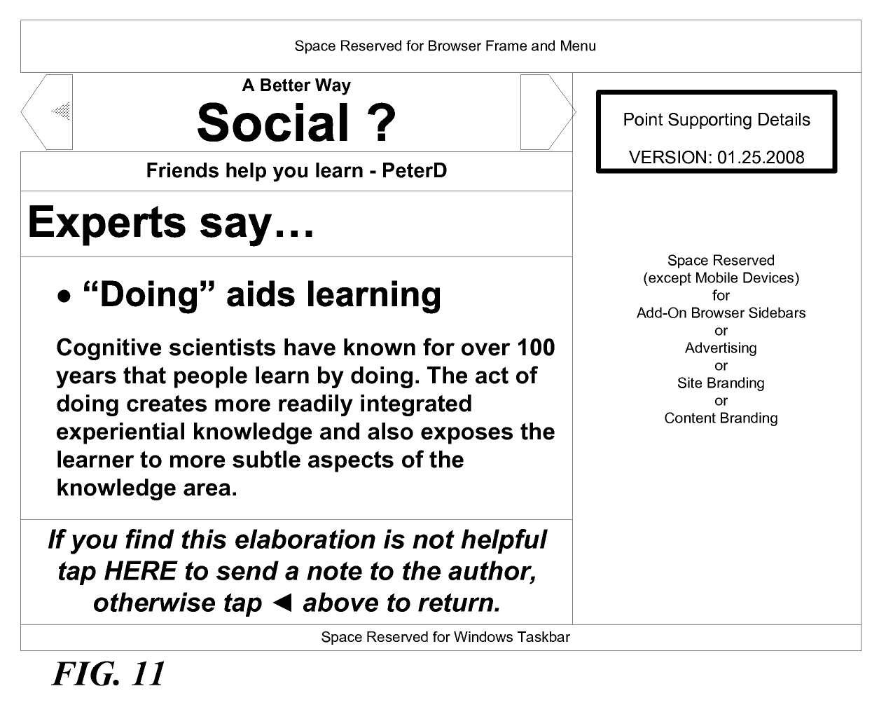

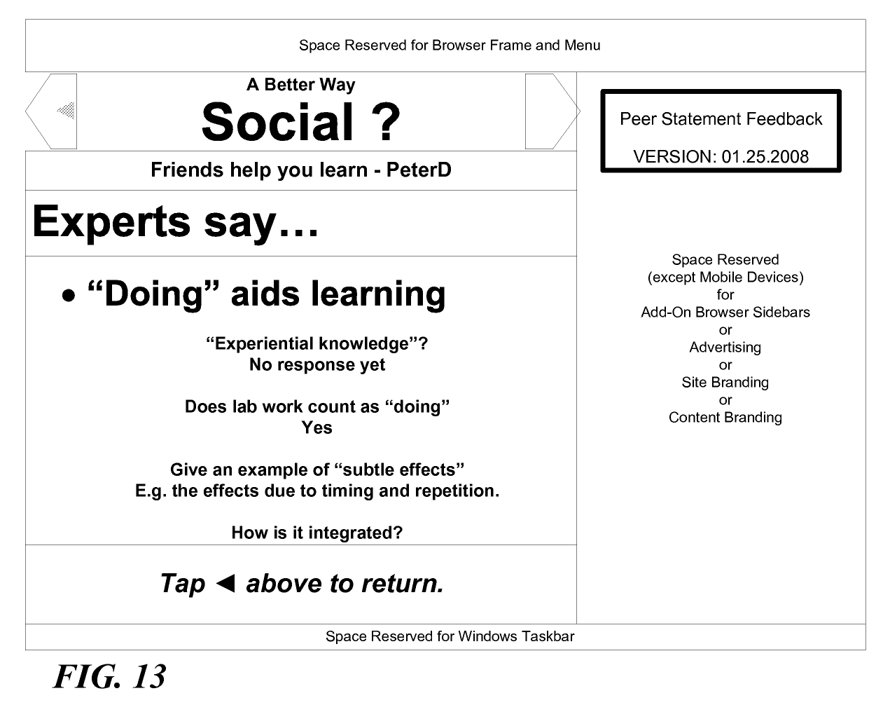

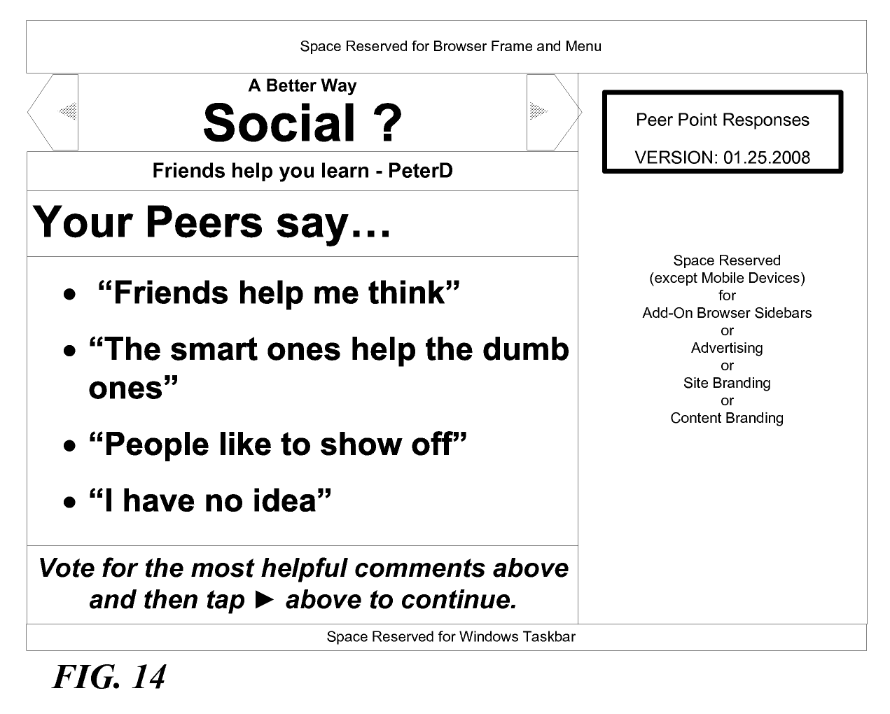

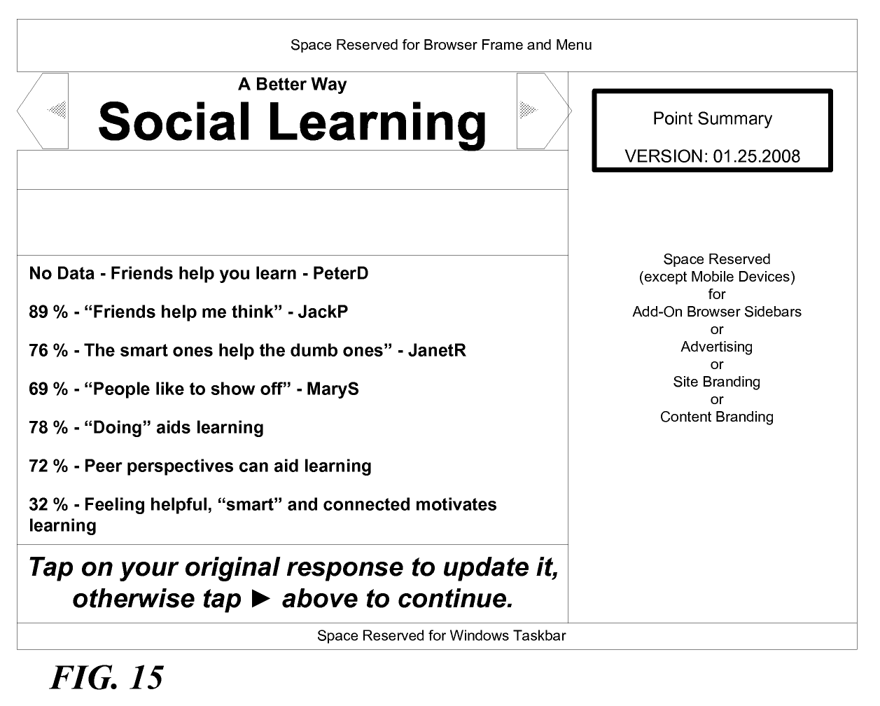

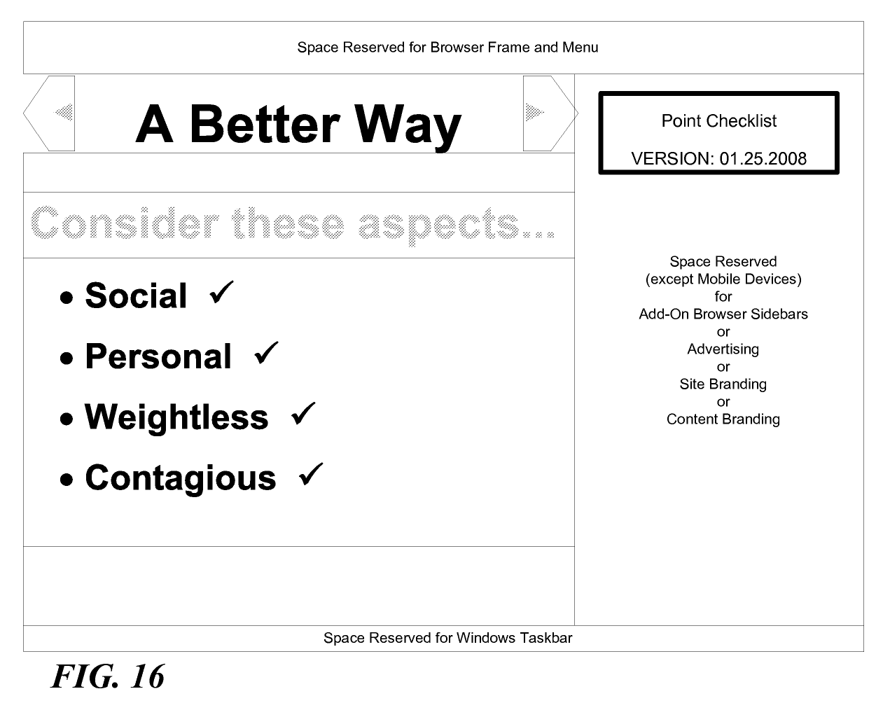

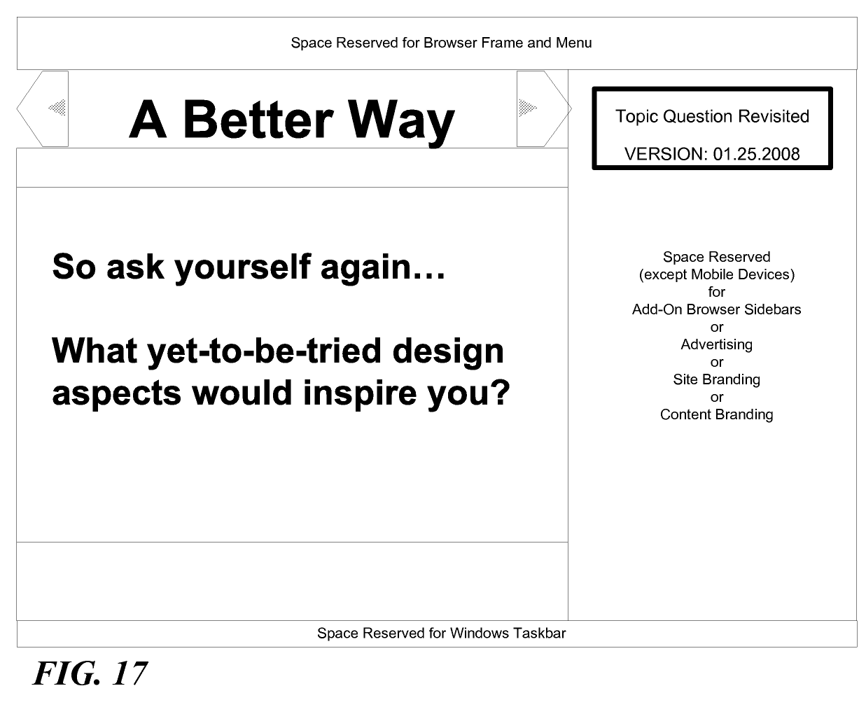

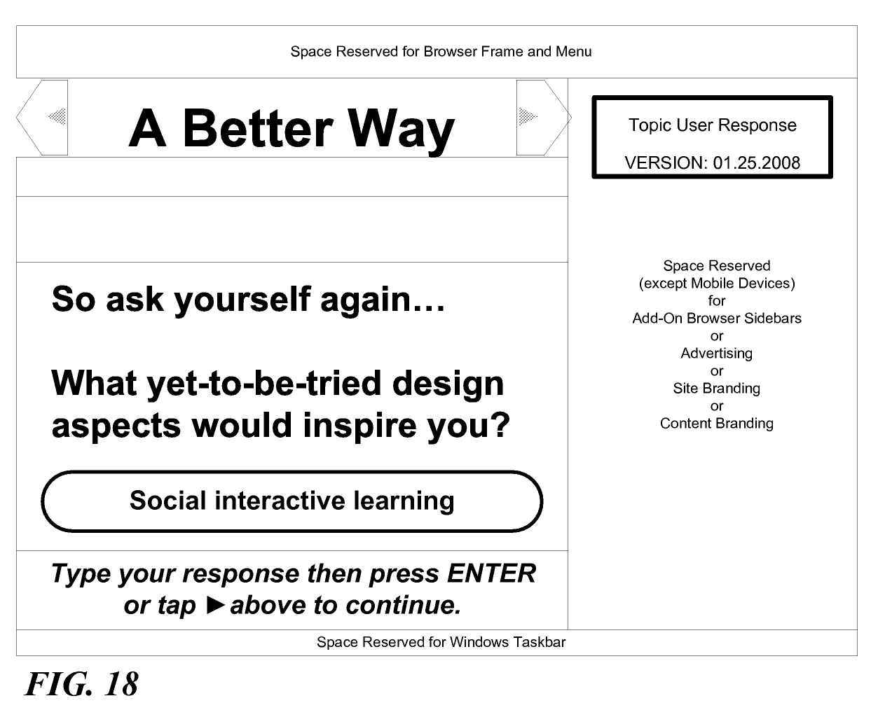

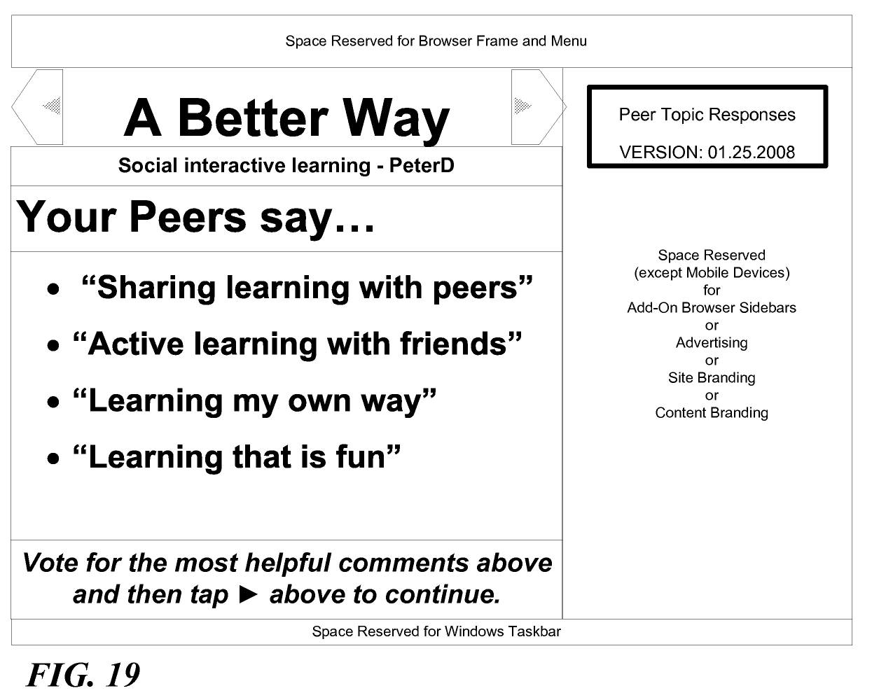

The steps of the novel method are presented as an exemplary flowchart 300 in FIG. 3A, an interaction path chart in FIG. 3B, a response selection chart in FIG. 3C, and a content scoring and selection flowchart 400 in FIG. 3D, with exemplary screen layouts in FIGS. 4-20, as follows. An interactive presentation has a content sequence, starting with an introduction 302 presenting a topic title 304 (as shown in FIG. 5), a topic question 306 (as shown in FIG. 6), and a checklist of author points. In this example, a list 308 (as shown in FIG. 7) includes four author points 310. The structure of the presentation also includes questions, such as questions 312 (as shown in FIG. 8) for each author point and question 352 (as shown in FIG. 17) for the topic question revisited, supporting statements 316 for each point (as shown in FIG. 10), and statement details 326 for each statement (as shown in FIG. 11), user-generated point responses 314 (as shown in FIG. 9), user-generated topic responses 354 (as shown in FIG. 18), peer-user generated point responses 318 (as shown in FIG. 14), peer topic responses 356 (as shown in FIG. 19,) user-selected peer statement(s) 320, statement feedback 336 (as shown in FIG. 13), and point summaries 322 for each point (as shown in FIG. 15). A checklist 324 (as shown in FIG. 16) is also updated with each point. The user input proceeds interactively according to the following flow.

Initially, one of the expert points from list 308 (as shown in FIG. 7) of the author predefined points is presented for consideration by an individual user. A predefined point question 312 for that point (as shown in FIG. 8) is then presented to the user, and the individual user is required to provide a “perspective” on the point by input of a response 314 to the predefined point question (as shown in FIG. 9). The individual user-generated point response is forwarded to the system for aggregation and storage (e.g., on a server hard drive—not shown) as part of the user feedback data that are being accumulated, and for future display by the system with other users and review by the author.

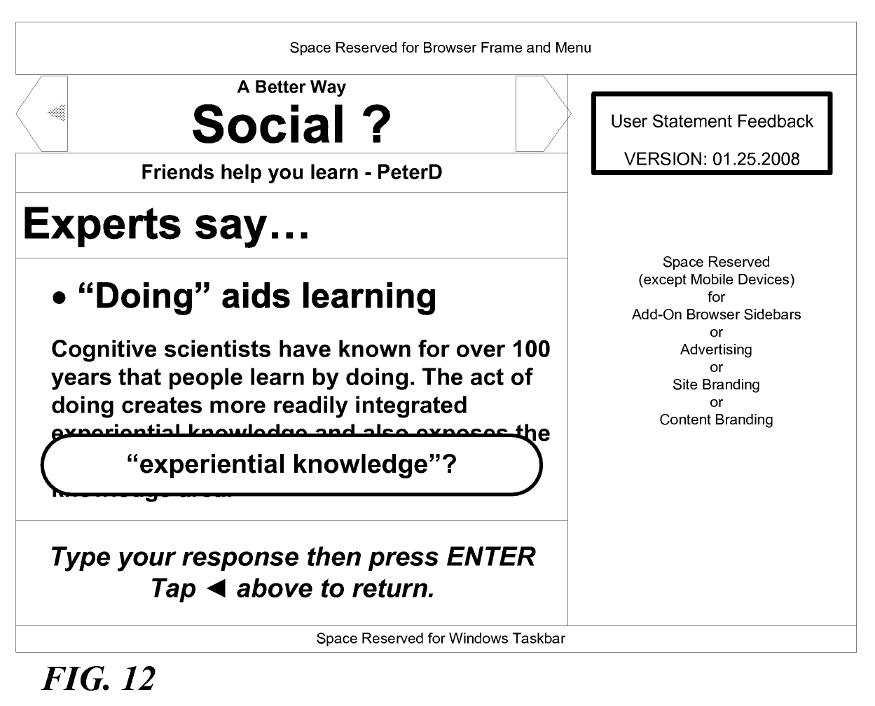

Next, a manageable number (e.g., three) of point supporting statements 316 (as shown in FIG. 10) is presented to the individual user in the context of the user point response. Thus, for the predefined point question for which the user provided input, an appropriate set of supporting statements is presented. The individual user is then prompted to either accept those supporting statements “as is” and move forward with the presentation, or select one of the supporting statements and “drill down” to a corresponding set of statement details 326 (as shown in FIG. 11), wherein one set of statement details 330 is provided for each supporting statement. A selection 328 by the user of a supporting statement to enable the user to view the statement details for that selected supporting statement sends a message to the system indicating the supporting statement that was selected and influences the “score” for the supporting statement selected by the user. The individual user is then prompted to either accept those statement details and return to supporting statements 316 (as shown in FIG. 10), or input and send user statement feedback 334 in a block 332 (as shown in FIG. 12) to the expert or author before returning to the statement details. A user's decision to provide feedback regarding a statement also sends a message to the system and influences the “score” for the supporting statement as well as forwards the individual user statement feedback to the system for future display and review by the author. The decision by the user to provide a feedback message regarding a supporting statement also influences the selection of the peer-user point responses and peer-user topic responses that are subsequently displayed to the user. Before returning the user to the supporting statement, system-selected peer statement feedback 336 (as shown in FIG. 13), which is in response to point statement details 326 (as shown in FIG. 11), along with the user statement feedback just input, are then displayed to the user in the context of the user point response. A filtering approach can be used to select a subset of the plurality of peer feedback statements thus far collected, for presentation to the user, so that at least some of the peer feedback statements presented were provided by peer users who are similar to the user, in their response to the presentation.

In addition, the aggregated peer-user point responses can be filtered for potential relevance to the user (for example, by applying a Peer User or Relevance algorithm) to influence the selection of the peer-user point responses, and a manageable number of the peer-user point responses (e.g., four) after such filtering is applied are selected for display in random order to the user as peer-user point responses 318 (shown in FIG. 14). The peer-user point responses selected are presented to the individual user in the context of the user's own point response, i.e., based on what the user selects from each list of options—but not based on any parsing of the user's statements.

For each point, the individual user is prompted to “score” at least one of peer-user point responses presented 320 (as shown in FIG. 14), before moving on with the presentation, i.e., by selecting the best of the peer-user responses presented. This user action sends one or more messages to the system and influences the score for each of the peer-user point responses presented, which adds to the user feedback data being accumulated. When implementing this step, aggregated user point responses are filtered for relevance to the individual user, and a manageable number (such as four) are selected for display to the individual user as peer-user point responses. The scores for the individual peer-user point responses and the expert point supporting statements are each updated using an algorithm operating on the total of the aggregated user interactions with them, so that the scores are updated for each user as the user makes choices from among the presented options. The user's point response is then presented to the user, along with a manageable number (e.g., three) of selected peer-user point responses—each with their scores, and the expert point supporting statements—each with their scores.

As indicated in a block 340, at anytime the user point response is displayed 342, in a step 344, the user may either move on with the presentation or update (edit) their own user point response before moving on with the presentation points, in a step 346. If the user elects to update their response, this behavior results in a revised user point response being forwarded to the system for aggregation in the user feedback data and future display by the system.

After the user completes entry of feedback scoring selections for peer-user statements 320 (as shown in FIG. 14), a point summary 322 (as shown in FIG. 15) is displayed for the author point that has now been completed; the scores for the peer responses are included in this point summary. A point checklist 324 (as shown in FIG. 16) then enumerates each of the points that have been reviewed by the user, and if any remain for the current topic, the user is presented with the next author point 312 (as shown in FIG. 8—but for the next point, “Personal”), for which feedback will be solicited.

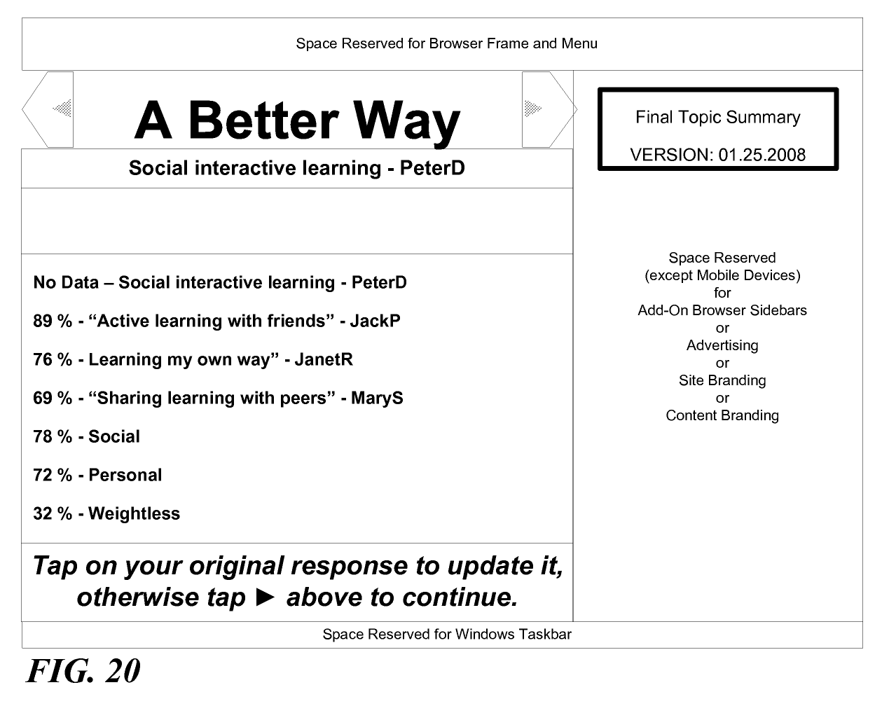

A final review block 350 includes a step 352 (as shown in FIG. 17) that revisits the topic question and solicits any further response from the user in a step 354 (as shown in FIG. 18). The final review gives the user an opportunity to suggest additional or alternative point(s) for use with the topic. Peer-user topic responses are presented to the user in a step 356 (as shown in FIG. 19). For the topic, the individual user is prompted to “score” at least one of the peer-user topic responses presented 356 by selecting one or more as the most helpful in a step 358 (as shown in FIG. 19), before moving on with the presentation. Thus, the user is asked to select the best of the peer-user responses presented. This user action sends one or more messages to the system and influences the score for each of the peer-user topic responses presented, which adds to the user feedback data being accumulated. When implementing this step, aggregated user topic responses are filtered for relevance to the individual user, and a manageable number (such as four) are selected for display to the individual user as peer-user topic responses. The scores for the individual peer-user topic responses and the expert points are each updated using an algorithm operating on the total of the aggregated user interactions with them, so that the scores are updated for each user as the user makes choices from among the presented options. A step final topic summary 360 (as shown in FIG. 20) presents the individual user's topic response to the user, along with a manageable number (e.g., three) of selected peer-user topic responses—each with their scores, and the expert points, before exiting the module in a step 362.

### Exemplary Algorithm for Determining Peer User Proximity or Relevance

The following discussion provides an example that explains one embodiment of a method used by the system to automatically determine the peer-user responses that are automatically selected by the system for presentation to each individual user who is interacting with the presentation. The intent of the method described herein is to identify those peer user responses that appear to have the “greatest potential relevance” (or proximity) to the current user.

While the database aggregates all individual user responses for the initial point questions, each individual user is presented with only four of these aggregated “peer point responses” for selection in their tailored version of the presentation. The peer point responses of greatest potential relevance to each individual user are identified based on the user's “proximity” to other users who have already completed the presentation. “Proximity” is determined by a formula that takes into account: (1) user interactions with the presentation (i.e., input provided by the current user while experiencing the presentation); and, (2) user selections relative to other users' interactions and selections (such as the user choosing the “best” of the peer-user responses).

User interactions that are tracked and added to the user-generated feedback include: (1) a determination (Yes/No) by the user to “drill-down” with regard to any of the point supporting statements; and, (2) a determination (Yes/No) by the user as to whether to provide a user statement as feedback for any point supporting statement.

FIGS. 3B and 3C illustrate further details of an exemplary approach for practicing the present novel method. In the exemplary embodiment shown in FIG. 3B, a user may be presented with an interactive presentation with a content sequence and structure that includes four points, with each point enabling user interaction with point content, including “Drill-down 1,” “Feedback 1,” “Drill-down 2,” “Feedback 2,” “Drill-down 3,” and “Feedback 3.” In accord with the present novel approach, for each point content, if a user chooses to have an interaction with the point content, a data value of “1” for that point content and for that user is stored in non-volatile memory as part of the user-generated feedback data.

In the example of FIG. 3B, hypothetical sets of interactions for the three users User A, User B, and User C are indicated for each of “Point 1,” “Point 2,” “Point 3,” and “Point 4” that are presented sequentially to each user. “User A” is indicated to have had interactions with “Drill-down 2” and “Drill-down 3” for “Point 1,” “Drill-down 2” for “Point 2,” “Drill-down 1” for “Point 3,” and “Drill-down 1” for “Point 4”. User B is indicated to have had interactions with “Drill-down 3” and “Feedback 3” for “Point 1,” “Drill-down 1” for “Point 2,” “Drill-down 1” and “Feedback 1” for “Point 3,” and “Drill-down 1” for “Point 4”. User C is indicated to have had interactions with “Drill-down 1” for “Point 1,” “Drill-down 2” and “Feedback 2” for “Point 2,” “Drill-down 1” for “Point 3,” and “Drill-down 3” for “Point 4”. FIG. 3B thus illustrates an example that shows hypothetical interaction “paths” taken by a User A in a presentation already completed by both a User B and a User C. (In both FIGS. 3B and 3C, User A interactions/selections are indicated by solid ovals, User B interactions/selections by dotted line ovals, and User C interactions/selections by dash line ovals).

“Interaction Proximity” is said to be higher between users if the users share common drill-down and common feedback decisions up to a given time in the presentation. In the above example shown in FIG. 3B, User A shares three overlaps with User B and two overlaps with User C. Therefore, User A has a greater proximity to User B than to User C in regard to the interaction portion of the method.

The formula for determining the interaction proximity value (“IPv”) between the current user and a peer user who previously completed the presentation is as follows: IPv=(number of shared overlaps)/(total number of possible overlaps)×(number of user drill-downs & feedback)/(number of corresponding peer user drill-downs and feedback). Note that as the user interacts with the presentation, the number of possible overlaps changes. Initially in this example, it is six as a user interacts with Point 1. By the time the user has finished interacting with Point 3 of the presentation, the number of possible overlaps has risen to 18.

Table 1, which follows, details the value of IPv between current User A and both User B and User C for each stage or Point in the interaction (where the calculations assume that User B and User C have already completed the interactive presentation).

TABLE 1
Ipv

| | Point 1 | Point 2 | Point 3 | Point 4 |
|---|---|---|---|---|
| User A/User B | 1/6 * 2/2 = 0.17 | 1/12 * 3/3 = 0.08 | 2/18 * 4/5 = 0.09 | 3/24 * 5/6 = 0.10 |
| User A/User C | 0/6 * 2/1 = 0.00 | 1/12 * 3/3 = 0.08 | 2/18 * 4/4 = 0.11 | 2/24 * 5/5 = 0.08 |

In flowchart 400 shown in FIG. 3D, a user inputs a response 412 to a point question that is stored in a non-volatile memory 450 as user text response data 432. In response to supporting statements 414 that are then presented, the user either accepts the supporting statements or selectively drills down to access supporting statement details 402 for one or more of the statements. The user can provide feedback 404 on any of the statement or statement details an exemplary Content Scoring and Selection Algorithm 420 employs the method described 450 above to calculate “IPv” values for each peer-user relative to the current user based on the user-generated feedback data collected for each user interaction 410 stored in non-volatile memory 450 and selects for presentation to the current user, the two best peer-user responses 422a and 422b, for the current point, that were provided by the peer users who have the greatest IPv values. Content Scoring and Selection Algorithm 420 also employs a “seeding algorithm” in a manner common to the use of “seeding algorithms” in connection with its IPv calculation method, to select for presentation to the current user, two seeded best peer-user responses 422c and 422d, for the current point. The user then selects the best of the responses, which effectively provides scoring 424 of the responses.

### User Selections

Selections by the user of the options provided in the presentation that are tracked and added to the user-generated feedback data include the peer-user point responses selected by the user for each point question. FIG. 3C illustrates exemplary hypothetical peer-user point response (“PPR”) selections made by User A in a presentation that has already been completed by both User B, and User C.

In the example shown in FIG. 3C, hypothetical sets of PPR interactions for User A, User B, and User C are indicated for each of “Point 1,” “Point 2,” “Point 3,” and “Point 4” that are presented sequentially to each user. User A is indicated to have had selected “PPRUserR” and “PPRUserT” for “Point 1,” “PPRUserR” and “PPRUserT” for “Point 2,” “PPRUserS” for “Point 3,” and “PPRUserR” for “Point 4”. User B is indicated to have had selected “PPRUserS” and “PPRUserT” for “Point 1,” “PPRUserS” for “Point 2,” “PPRUserS” and “PPRUserU” for “Point 3,” and “PPRUserQ” and “PPRUserR” for “Point 4”. UserC is indicated to have had selected “PPRUserU” for “Point 1,” “PPRUserS” for “Point 2,” “PPRUserQ” and “PPRUserS” for “Point 3,” and “PPRUserR” for “Point 4”.

“Selection Proximity” is said to be higher between users (i.e., the users are more closely alike) if the users share common peer-user point response selections. In the example illustrated in FIG. 3C, User A shares three overlaps (common selection choices) with User B and two overlaps with User C. Therefore, User A has greater proximity to User B than to User C in regard to the selections parameter. The formula for determining the Selection Proximity value (“SPv”) between the new user and previously active users is: SPv=(number of shared overlaps)/(total number of user selections).

Exemplary values of the SPv between the current user (i.e., User A) and both User B and User C are shown in Table 2, which follows below, for each stage in the presentation interaction (where the calculations assume that User B and User C have already completed the interactive presentation).

TABLE 2
SPv

| | Point 1 | Point 2 | Point 3 | Point 4 |
|---|---|---|---|---|
| User A/User B | 1/2 = 0.50 | 1/4 = 0.25 | 2/5 = 0.40 | 3/6 = 0.50 |
| User A/User C | 0/2 = 0.00 | 0/4 = 0.00 | 1/5 = 0.20 | 2/6 = 0.33 |

### User Proximity

The formula for determining user proximity value (“UPv”) between the new user and previously active users for each stage of the interaction is: UPv=IPv+SPv. It is the UPv value that is thus used to determine which peer-user responses to present to the current user. The other users with the highest UPv are the ones whose response will be automatically presented to the current user, since those other users are most like the current user in regard to their interaction and selection history up to the current time in the presentation. In the example presented herein, it will be understood that only two other users are included to simplify the example, but it will be apparent that over time, the number of other users who have completed the presentation may become substantially larger in number (e.g., tens, hundreds, or even thousands), and the amount of the user-generated feedback data that has been collected may become very large in size.

Table 3, which follows below, illustrates exemplary UPv results for User A in regard to both User B and User C for each stage in interaction (these exemplary calculations assume the User B and User C have already completed the interactive presentation). The UPv results shown in Table 3 indicate that User B has the greatest proximity to User A at each stage (in this particular example).

TABLE 3
UPv

| | Point 1 | Point 2 | Point 3 | Point 4 |
|---|---|---|---|---|
| User A/User B | 0.17 + 0.5 = 0.67 | 0.08 + 0.25 = 0.33 | 0.09 + 0.40 = 0.49 | 0.10 + 0.50 = 0.60 |
| User A/User C | 0.00 + 0.00 = 0.00 | 0.08 + 0.00 = 0.08 | 0.11 + 0.20 = 0.31 | 0.08 + 0.33 = 0.41 |

In FIG. 3D, a Content Scoring and Selection Algorithm 440 employs the above method above to calculate IPv, SPv, and UPv values for each peer user relative to the current user based on the data collected for each user interaction 410 and user selection data 430 stored in non-volatile memory 450 and selects for presentation to the user, the three best peer-user responses 442 for the current point, that were input by the peer users who have the greatest UPv values relative to the current user.

### Application of User Proximity

As the other users having the greatest user proximity are determined at each stage in the presentation, the user responses for those other users will be chosen for inclusion in the presentation of the next stage or point in the topic of the presentation to the current user. Also, as more users have had a chance to interact with the presentation and complete it, the quantity and the quality of the user-generated feedback data will increase, since the proximity of the current user to other users who have already completed the presentation will be more accurately determined, which will enable the other user responses to be more accurately selected for presentation to the then current user who is experiencing the presentation.

### Other Considerations Contemplated for Method to Determine User Proximity

It is contemplated that the determination of other users who have the greatest proximity to the current user may also take into account other factors, as follows.

a. Interaction data, such as:
i. Number of user interactions with an element
ii. Interaction response rate with an element
iii. Number of interactions with other elements
iv. Order of interactions with other elements

b. User data such as:
i. Other interactions by the current user
ii. Interactions by “similar” other users, including:
   1. users who engaged in similar interactions such as those who scored previous elements the same;
   2. users who have identifiable similarities such as:
      a. demographics, e.g., age and education
      b. psychographics, e.g., lifestyle and personality
      c. geographic factors, e.g., attended same school or lived in the same city
      d. behavioral factors, e.g., use occasion and usage rate
iii. Interactions by all previous users

c. Element data such as:
i. Interactions with a specific element
ii. Interactions with all elements in the same presentation
iii. Interactions with all elements in “similar” presentations, for example:
   1. Similar in presentation length
   2. Similar in presentation topic
   3. Similar in presentation display platform
iv. Interactions with all elements in all presentation modules

d. System data such as:
i. interactions on the specific presentation platform
ii. interactions on “similar” presentation platforms, for example, platforms that are:
   1. similar in display size
   2. similar in user input mechanism(s)
   3. similar in use location or portability
iii. interactions on all presentation platforms

### SUMMARY

The present exemplary novel method and system capture and track all messages and input data derived each user's selections and statements during a presentation, and other interactions by the user with the presentation. The user-generated feedback data that results can be employed for purposes such as future review by the author and for controlling the manner in which the review progresses. User-generated feedback data can include (but are not limited to): individual user point response(s), supporting statement feedback, and scoring for each determined by the selections made by the users. To solicit useful input from the users, the presentation may include point supporting statements and supporting statement details, as well as peer-user generated responses and statement feedback, which can assist the users in better understanding the presentation content.

An important aspect of this novel approach is the presentation of selected peer-user point response, since such responses provide a comparison between the user's response and the responses of other users who have also reviewed the presentation. The scoring and filtering algorithm takes into account such factors as interaction data. The interaction data may include the number of user interactions with each element in the presentation, an interaction response rate with each element, a number of interactions with other elements, the order of interactions with other elements, and user data. The user data may include other interactions by the current user, interactions by “similar” previous users such as users who engaged in similar interactions, for example, by scoring previous elements the same, and users who have identifiable similarities. The identifiable similarities can include demographics such as age and education, psychographics such as lifestyle and personality, and geographic data such as city and school attended. Other identifiable similarities may be behavioral, such as use occasion and usage rate for interacting with presentations, perhaps in comparison with interactions by all previous users. Other components of the accumulated data may include element data such as interactions with each specific element of the presentation, interactions with all elements in the same presentation module, and interactions with all elements in “similar” presentation modules. Other presentation modules may be considered to be similar because they are similar in presentation length, similar in presentation topic, or similar in presentation display platform employed. Or, instead of considering only similar presentations, the user feedback data can include interactions with all elements, in all presentation modules.

The accumulated user feedback data can also include system data such as interactions on the specific presentation platform, and interactions on “similar” presentation platforms. A platform might be considered similar to a present platform if it is similar in display size, similar in user input devices, or similar in the location where it is used or its portability. However, the user feedback data may instead include interactions on all presentation platforms.

Utilizing at least some of the steps described above, one exemplary embodiment includes a presentation and feedback collection system comprising a system and structure that executes machine readable code that provides for prompting and aggregating user responses to content. This embodiment can also include a system for filtering and selecting aggregated user responses for potential relevance to each individual user, a system and structure for prompting user scoring of user content, a system for filtering and selecting aggregated user responses for relevance to each individual user, a system for scoring pre-authored content elements based on user interactions with them, and a system for scoring user-generated content elements based on aggregated user interactions with them. The user-generated data tracking provided by the present approach can provide useful information to an author of a presentation to enable the author to modify the presentation to address problems exhibited by users in understanding points or supporting statements, or to include additional points or supporting statements modified by users that improve the quality of the presentation and its relevance to an audience. In addition, the author feedback in response to user input regarding supporting statements or points in the presentation can help users by clarifying the intended meaning of the author or answering questions raised by the users.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for collecting user feedback data relative to predefined topical points, comprising the steps of:
(a) presenting individual users with predefined questions, each predefined question being related to different predefined topical points;
(b) soliciting input from the individual users for each predefined question presented;
(c) presenting the individual users with statements related to each predefined question presented to the individual users;
(d) selectively presenting the individual users with responses to the predefined question input by other users, based on the input by the individual users;
(e) enabling the individual users to select responses from among the responses input by the other users; and
(f) collecting the user feedback data in a data store, where the user feedback data are based upon the responses and selections made by all users who have been presented with the predefined questions.

2. A system for collecting user feedback data relative to predefined topical points, comprising:
(a) a nonvolatile storage for storing the user feedback data; and
(b) a computing device with which a user interacts, the computing device including a memory for storing machine readable and executable instructions, an output device, an input device, and a processor that is coupled to the non-volatile storage, the memory, the output device, and the input device, the processor executing the machine readable and executable instructions to carry out a plurality of functions, including:
(i) presenting a series of predefined questions to the user on the display, each predefined question being related to one of the predefined topical points;
(ii) for each predefined question presented, soliciting the user to provide a response using the input device, the response being added to the user feedback data;
(iii) for each predefined question presented to the user, presenting related statements to the user;
(iv) selectively presenting the user with a plurality of responses to each of the predefined questions that were previously input by other users, wherein the plurality of responses are automatically selected from the user input feedback data, based on input to the user input feedback data by the user;
(v) for each predefined question presented to the user, enabling the user to select one or more responses from the plurality of responses previously input by other users, as best, an indication of the one or more responses selected by the user being added to the user input feedback data; and
(vi) collecting the user feedback data in a data store maintained on the non-volatile storage, wherein the user feedback data are based upon the responses and selections made by all of the users who have responded to the questions.

3. A method for collecting user feedback data regarding a presentation, comprising the steps of:
(a) presenting a predefined point related to a topic of the presentation to a user on an output device, along with a predefined question associated with the predefined point;
(b) requesting the user to input a response to the predefined question;
(c) storing the response by the user in a non-volatile storage, as part of the user feedback data that are being collected;
(d) in a context of the predefined question to which the user input a response, presenting a plurality of supporting statements for review by the user;
(e) enabling the user to either:
(i) select at least one of the plurality of supporting statements to access further details, and in response to a selection of a supporting statement, displaying statement details for the supporting statement that was selected, and storing in the non-volatile storage an indication of each supporting statement that was selected, as part of the user feedback data; or
(ii) accept the plurality of supporting statements without selecting any supporting statement;
(f) presenting a plurality of peer-user responses to the predefined question, along with the response input by the user; and
(g) enabling the user to select at least one of the plurality of peer-user responses and storing an indication of each peer-user response selected by the user as part of the user feedback data, in the non-volatile storage.

4. The method of claim 3, further comprising the step of presenting a relative score for each of the plurality of peer-user responses that were presented to the user, based on the user feedback data that has been collected.

5. The method of claim 3, further comprising the step of presenting a relative score for each of the plurality of supporting statements.

6. The method of claim 3, wherein the presentation is accessed over a network using a computing device that communicates with at least one other computing device.

7. The method of claim 6, wherein each of the steps of storing comprises the step of conveying the part of the user feedback data to be stored over the network to a remote data store that comprises the non-volatile storage.

8. The method of claim 6, wherein the step of presenting the predefined point to the user comprises the step of enabling the user to access the presentation which is stored on the at least one other computing device over the network.

9. The method of claim 3, further comprising the step of repeating steps (a)-(g) for each of a plurality of predefined points and corresponding predefined questions comprising the presentation for which user feedback data are being collected.

10. The method of claim 9, further comprising the step of presenting to the user, a final review of responses input by the user and corresponding peer-user responses for each predefined point, and corresponding supporting statements and the predefined question to which the user input a response.

11. The method of claim 3, wherein if the user selects one of the plurality of supporting statements and thereby causes statement details to be displayed, further comprising the steps of enabling the user to:
(a) input at least one of a comment, a question, and a feedback to an author of the presentation regarding at least one of the supporting statement, and the statement details; and
(b) storing the at least one of the comment, the question, and the feedback input by the user as part of the user feedback data, in the non-volatile storage, to enable the author of the presentation to view the input by the user.

12. The method of claim 3, further comprising the steps of enabling the user to modify the response that the user previously input for the predefined question.

13. The method of claim 3, further comprising the steps of:
(a) presenting a final topic review to the user, in which the predefined points are presented to the user;
(b) requesting the user to modify any of the predefined points, and to add any additional points that the user considers relevant to the topic, any modification of the predefined points, and any additional point provided by the user being stored with the user feedback data;
(c) presenting a plurality of topic responses input by other users, to the user; and
(d) requesting the user to select at least one of the topic responses input by other users.

14. The method of claim 3, wherein the step of presenting the plurality of peer-user responses to the user comprises the step of selecting and presenting the peer-user responses for peer users who are most like the user in responding to the presentation.

15. The method of claim 14, wherein the step of selecting and presenting the peer-user responses to the user comprises the steps of:
(a) determining an interaction parameter for peer users that is an indication of how closely the interactions with the presentation of the peer users are like those of the user, up to that time in the presentation;
(b) determining a selection parameter for peer users that is an indication of how closely the selections by the peer users of options presented are like selections made by the user, up to that time in the presentation;
(c) combining the interaction parameter and the selection parameter for each of the other peer users in regard to the user, to provide a proximity value that indicates the peer users who are like the user in reviewing the presentation; and
(d) selecting the peer-user responses by the peer users having the highest proximity values, for presentation to the user.

16. A memory medium on which are stored machine readable and executable instructions for collecting user feedback data regarding a presentation, wherein when executed by a processor, the machine readable and executable instructions cause the processor to carry out a plurality of functions, including:
(a) presenting a predefined point related to a topic of the presentation to a user on an output device, along with a predefined question associated with the predefined point;
(b) requesting the user to input a response to the predefined question;
(c) storing the response by the user in a non-volatile storage as part of the user feedback data being collected;
(d) in a context of the predefined question to which the user input a response, presenting a plurality of supporting statements for review by the user;
(e) enabling the user to either:
(i) select at least one of the plurality of supporting statements to access further details, and in response to a selection of a supporting statement, displaying statement details for the supporting statement that was selected, and storing in the non-volatile storage an indication of each supporting statement that was selected, as part of the user feedback data; or
(ii) accept the plurality of supporting statements without selecting any supporting statement;
(f) displaying a plurality of peer-user responses to the predefined question, along with the response input by the user; and
(g) enabling the user to select at least one of the plurality of peer-user responses and storing an indication of each peer-user response selected by the user as part of the user feedback data, in the non-volatile storage.

17. The memory medium of claim 16, wherein the machine readable and executable instructions further cause the processor to present a relative score to the user, for each of the plurality of peer-user responses that were presented to the user, based on the feedback data collected.

18. The memory medium of claim 16, wherein the machine readable and executable instructions further cause the processor to present a relative score to the user, for each of the plurality of supporting statements.

19. The memory medium of claim 16, wherein the machine readable and executable instructions further cause the processor to repeat steps (a)-(g) for each of a plurality of predefined points and corresponding predefined questions comprising the presentation for which user feedback data are being collected.

20. The memory medium of claim 16, wherein if the user selects one of the plurality of supporting statements and thereby causes statement details to be displayed, the machine readable and executable instructions further cause the processor to enable the user to:
(a) input at least one of a comment, a question, and a feedback to an author of the presentation regarding at least one of the supporting statement, and the statement details; and
(b) storing at least one of the comment, the question, and the feedback input by the user as part of the user feedback data, in the non-volatile storage, to enable the author of the presentation to view the comment input by the user.

21. The memory medium of claim 16, wherein the machine readable and executable instructions further cause the processor to enable the user to modify the response that the user previously input for the predefined question.

22. A system for collecting user feedback data regarding a presentation, comprising:
(a) a non-volatile storage; and
(b) a user computing device for use in accessing the presentation, the user computing device including:
(i) a memory in which are stored machine readable and executable instructions;
(ii) an output device on which at least one of text and graphics is presented to a user;
(iii) an input device for accepting a user input; and
(iv) a processor that is coupled to the memory, the output device, the input device, and the non-volatile storage, the processor executing the machine readable and executable instructions to carry out a plurality of functions, including:
(1) presenting a predefined point related to a topic of the presentation to a user on the output device, along with a predefined question associated with the predefined point;
(2) requesting the user to input a response to the predefined question using the input device;
(3) storing the response by the user in the non-volatile storage, as part of the user feedback data that are being collected;
(4) in a context of the predefined question to which the user input a response, presenting a plurality of supporting statements on the output device, for review by the user;
(5) enabling the user to either:
(A) select at least one of the plurality of supporting statements using the input device to access further details, and in response to a selection of a supporting statement, presenting statement details on the output device for the supporting statement that was selected on the display, and storing in the non-volatile storage, an indication of the supporting statement that was selected, as part of the user feedback data; or
(B) using the input device, accept the plurality of supporting statements without selecting any supporting statement;
(6) presenting a plurality of peer-user responses to the predefined question on the output device, along with the response input by the user; and
(7) enabling the user to employ the input device to select one of the plurality of peer-user responses and storing an indication of the peer-user response selected by the user as part of the user feedback data, in the non-volatile storage.

23. The system of claim 22, wherein, based on the feedback data collected, the machine readable and executable instructions stored in memory further cause the processor to present a relative score for each of the plurality of peer-user responses that were previously presented to the user.

24. The system of claim 22, wherein the machine readable and executable instructions stored in memory further cause the processor to present a relative score for each of the plurality of supporting statements.

25. The system of claim 22, further comprising a network interface that is coupled to the processor and to a network, wherein the non-volatile storage comprises a data store that is disposed at a remote location, and wherein the user feedback data are conveyed through the network interface and over the network to the non-volatile storage.

26. The system of claim 25, further comprising a server computing device that is coupled to the non-volatile storage, the server computing device providing the presentation to the user computing device over the network, through the network interface.

27. The system of claim 22, wherein the machine readable and executable instructions stored in memory further cause the processor to repeat functions (1)-(7) for each of a plurality of predefined points and corresponding predefined questions comprising the presentation for which user feedback data are being collected.

28. The system of claim 27, wherein the machine readable and executable instructions stored in memory further cause the processor to present to the user a final review of responses input by the user and corresponding peer-user responses for each predefined point, and corresponding supporting statements and the predefined question to which the user input a response.

29. The system of claim 22, wherein if the user selects one of the plurality of supporting statements and thereby causes statement details to be presented, the machine readable and executable instructions stored in memory further cause the processor to:
(a) enable the user to use the input device to input a comment to an author of the presentation regarding the statement details; and
(b) store the comment input by the user as part of the user feedback data, in the non-volatile storage, to enable the author of the presentation to subsequently access the comment input by the user.

30. The system of claim 22, wherein the machine readable and executable instructions stored in memory further cause the processor to enable the user to modify the response that the user previously input for the predefined question.

31. The system of claim 22, wherein the machine readable and executable instructions stored in memory further cause the processor to:
(a) present a final topic review to the user, in which the predefined points are presented to the user;
(b) request the user to modify any of the predefined points, and to add any additional points that the user considers relevant to the topic, any modification of the predefined points, and any additional point provided by the user being stored with the user feedback data;
(c) present to the user a plurality of topic responses input by other users; and
(d) request the user to select at least one of the topic responses input by other users as best.

32. The system of claim 22, wherein the machine readable and executable instructions stored in memory further cause the processor to select and present to the user, the peer-user responses for peer users who are most like the user in responding to the presentation.

33. The system of claim 32, wherein the machine readable and executable instructions stored in memory further cause the processor to select and present the peer-user responses by:
(a) determining an interaction parameter for peer users that is an indication of how closely the interactions with the presentation of the peer users are like those of the user, up to that time in the presentation;
(b) determining a selection parameter for peer users that is an indication of how closely the selections by the peer users of options presented are like selections made by the user, up to that time in the presentation;
(c) combining the interaction parameter and the selection parameter for each of the other peer users in regard to the user, to provide a proximity value that indicates the peer users who are like the user in reviewing the presentation; and
(d) selecting the peer-user responses by the peer users having the highest proximity values, for presentation to the user.
